(19) United States
(12) Patent Application Publication
(10) Pub. No.: US 2015/0203723 A1
(43) Pub. Date: Jul. 23, 2015

(54) Substituted Cellulose Ester Adhesives and Methods and Articles Relating Thereto

(71) Applicant: Celanese Acetate LLC, Irving, TX (US)

(72) Inventors: Michael Combs, Shady Spring, WV (US); Thomas Garrett, Narrows, VA (US); Chad Prunesti, Lindside, WV (US); Martin Jakob, Frankfurt (DE); Yi (Julie) Li, Blacksburg, VA (US); Xiaoyan Tu, Blacksburg, VA (US)

(21) Appl. No.: 13/985,318

(22) PCT Filed: Sep. 24, 2012
(86) PCT No.: PCT/US2012/056802

§ 371 Date: Aug. 14, 2013

(51) Int. Cl. C09J 101/12; C08L 1/12

(52) U.S. Cl. CPC C09J 101/12; C08L 1/12

(57) ABSTRACT

A substituted cellulose ester having a cellulose backbone with an organic ester substituent and an inorganic ester substituent derived from the inorganic ester oxoacid catalyst may be utilized in adhesive compositions and articles produced therewith. Producing a substituted cellulose ester may, in some embodiments, involve providing a cellulose ester mixture that comprises a cellulose ester and a solvent; and hydrolyzing a mixture that comprises the cellulose ester mixture, water, and an inorganic ester oxoacid catalyst so as to yield a substituted cellulose ester having a cellulose backbone with an organic ester substituent and an inorganic ester substituent derived from the inorganic ester oxoacid catalyst.

### BACKGROUND

The present invention relates to substituted cellulose ester adhesives, and articles and methods relating thereto.

The most common wood adhesives are urea and melamine formaldehyde resins because they strongly bind to wood substrates. However, it is believed that these adhesives may release formaldehyde into the surrounding environment over time, which is undesirable because formaldehyde is a known carcinogen, has a pungent odor, and has been shown to induce asthma attacks in relatively low doses.

Accordingly, formaldehyde-free wood adhesives are of much interest. However, alternatives, like polyurethane-based wood adhesives, often have less than satisfactory adhesive properties, which produce, for example, low-quality wood laminates. Therefore, formaldehyde-free wood adhesives that exhibit adhesive properties comparable to or better than urea and melamine formaldehyde resins would be of value.

### SUMMARY OF THE INVENTION

The present invention relates to substituted cellulose ester adhesives, and articles and methods relating thereto.

In one embodiment of the present invention a method may comprise: providing a cellulose ester mixture that comprises a cellulose ester and a solvent; and hydrolyzing a mixture that comprises a cellulose ester mixture, water, and an inorganic ester oxoacid catalyst so as to yield a substituted cellulose ester having a cellulose backbone with an organic ester substituent and an inorganic ester substituent derived from the inorganic ester oxoacid catalyst.

In another embodiment of the present invention a method may comprise: swelling a cellulosic material in a solvent in the presence of an activating agent, thereby yielding an activated cellulose; esterifying the activated cellulose in the presence of a first inorganic ester oxoacid catalyst and an organic esterification reactant, thereby yielding a cellulose ester mixture; and hydrolyzing the cellulose ester mixture in the presence of water and a second inorganic ester oxoacid catalyst, thereby yielding a substituted cellulose ester.

In yet another embodiment of the present invention a method may comprise: esterifying a cellulosic material in the presence of a first inorganic ester oxoacid catalyst and an organic esterification reactant, thereby yielding a cellulose ester mixture, the cellulosic material comprising at least one selected from the group consisting of cellulose sulfate, cellulose phosphate, cellulose nitrate, and any combination thereof; and hydrolyzing the cellulose ester mixture in the presence of water and a second inorganic ester oxoacid catalyst, thereby yielding a substituted cellulose ester.

In one embodiment of the present invention an adhesive may comprise: a substituted cellulose ester having a cellulose backbone with an organic ester substituent and an inorganic ester substituent, wherein the adhesive is substantially formaldehyde-free.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 provides a nonlimiting example of a substituted cellulose ester synthesis route according to at least some embodiments of the present invention.

FIG. 2 provides a nonlimiting example of a substituted cellulose ester synthesis route according to at least some embodiments of the present invention.

FIG. 3 provides a nonlimiting example of a substituted cellulose ester synthesis route according to at least some embodiments of the present invention.

### DETAILED DESCRIPTION

The present invention relates to substituted cellulose ester adhesives, and articles and methods relating thereto.

The present invention provides for, in some embodiments, formaldehyde-free adhesives produced from cellulosic materials. In addition to the formaldehyde-free advantages, the adhesives presented herein are advantageously derived from renewable cellulosic sources. Consequently, the adhesive compositions are believed to be, to some degree, degradable. That is, over the long-term the adhesive compositions described herein, under the proper conditions (e.g., in a landfill), may degrade to enable and/or enhance degradation of articles produced therewith. Accordingly, the adhesive compositions described herein provide for articles that are thought to be both health-friendly and environmentally-friendly, both in production and decomposition.

It should be noted that when “about” as used herein in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

### Substituted Cellulose Ester Adhesive Compositions

As used herein, the terms “substituted cellulose ester adhesive” and “SCE-adhesive” refer to an adhesive composition that comprises a substituted cellulose ester. As used herein, the term “substituted cellulose ester” refers to a polymeric compound having a cellulose polymer backbone having an organic ester substituent and an inorganic ester substituent. As used herein, the term “inorganic ester substituent” refers to an ester that comprises an oxygen bound to an R group and an inorganic, nonmetal atom (e.g., sulfur, phosphorus, boron, and chlorine). It should be noted that inorganic esters encompass esters derived from oxoacids that comprise both inorganic, nonmetal atoms and carbon atoms, e.g., alkyl sulfonic acids like methane sulfonic acid. Synthesis of substituted cellulose esters are described further herein.

Organic ester substituents of a substituted cellulose ester described herein may include, but are not limited to, C₁-C₂₀ aliphatic esters (e.g., acetate, propionate, or butyrate), aromatic esters (e.g., benzoate or phthalate), substituted aromatic esters, and the like, any derivative thereof, and any combination thereof.

In some embodiments, the degree of substitution of the organic ester substituents of a substituted cellulose ester described herein may range from a lower limit of about 0.2, 0.5, or 1 to an upper limit of less than about 3, about 2.9, 2.5, 2, or 1.5, and wherein the degree of substitution may range from any lower limit to any upper limit and encompass any subset therebetween.

Inorganic ester substituents of a substituted cellulose ester described herein may include, but are not limited to, hypochlorite, chlorite, chlorate, perchlorate, sulfite, sulfate, sulfonates (e.g., taurine, toluenesulfonate, C₁-C₁₀ alkyl sulfonate, and aryl sulfonate), fluorosulfate, nitrite, nitrate, phosphite, phosphate, phosphonates, phosphinates, alkyl phosphates, borate, and the like, any derivative thereof, and any combination thereof.

In some embodiments, the weight percent of the inorganic, nonmetal atom of the inorganic ester substituent of a substituted cellulose ester described herein may range from a lower limit of about 0.01%, 0.05%, or 0.1% to an upper limit of about 8%, 5%, 3%, 1%, 0.5%, 0.25%, 0.2%, or 0.15%, and wherein the weight percent may range from any lower limit to any upper limit and encompass any subset therebetween.

Substituted cellulose esters for use in conjunction with SCE-adhesives of the present invention may be derived from any suitable cellulosic source. Suitable cellulosic sources may include, but are not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), recycled cellulose, and the like, and any combination thereof. Unexpectedly, it has been discovered, and is described further herein, the adhesive properties of SCE-adhesives may depend on, inter alia, the cellulosic source from which the substituted cellulose esters are derived. Without being limited by theory, it is believed that other components, e.g., lignin and/or hemicelluloses, and concentrations thereof in the various cellulosic sources contribute to the differences in adhesive properties of the substituted cellulose esters derived therefrom.

In some embodiments, substituted cellulose esters, and consequently SCE-adhesives of the present invention and articles produced therewith, may be degradable, including biodegradable and/or chemically degradable. Without being limited by theory, it is believed that at least some inorganic ester substituents may be more susceptible to hydrolysis than a corresponding cellulose ester that does not comprise (or minimally comprises) inorganic ester substituents. Further, after some inorganic ester substituents undergo hydrolysis, a strong acid may be produced, which may further speed degradation.

In some embodiments, SCE-adhesives of the present invention may comprise at least one substituted cellulose ester and a solvent. Suitable solvents for use in conjunction with SCE-adhesives of the present invention may include, but are not limited to, water, acetone, methanol, ethanol, methylethyl ketone, methylene chloride, dioxane, dimethyl formamide, tetrahydrofuran, acetic acid, dimethyl sulfoxide, N-methyl pyrrolidinone, dimethyl carbonate, diethyl carbonate, ethylene carbonate, propylene carbonate, and the like, any derivative thereof, and any combination thereof. By way of nonlimiting example, SCE-adhesives of the present invention may, in some embodiments, comprise at least one substituted cellulose ester having an organic ester substituent degree of substitution of greater than about 0 to about 1, an aqueous solvent, and optionally an organic solvent. By way of another nonlimiting example, SCE-adhesives of the present invention may, in some embodiments, comprise at least one substituted cellulose ester having an organic ester substituent degree of substitution of about 0.7 to about 2.7 and a mixed solvent that comprises an aqueous solvent and an organic solvent (e.g., acetone). By way of yet another nonlimiting example SCE-adhesives of the present invention may, in some embodiments, comprise at least one substituted cellulose ester having an organic ester substituent degree of substitution of about 2.4 to less than about 3, an organic solvent (e.g., acetone), and optionally an aqueous solvent at about 15% or less by weight of the organic solvent.

In some embodiments, SCE-adhesives of the present invention may be formaldehyde-free. In some embodiments and SCE-adhesive for use in conjunction with an article of the present invention may be substantially formaldehyde-free, i.e., comprise less than 0.01% formaldehyde by weight of the substituted cellulose acetate of the SCE-adhesive composition.

In some embodiments, SCE-adhesives of the present invention may be formaldehyde-free, which may also be described as “an adhesive with no added formaldehyde.” In some embodiments, SCE-adhesives of the present invention may be substantially formaldehyde-free, i.e., comprise less than 0.01% formaldehyde by weight of the substituted cellulose acetate of the SCE-adhesive composition.

In some embodiments, SCE-adhesives of the present invention may further comprise an additive. Additives suitable for use in conjunction with SCE-adhesives of the present invention may include, but are not limited to, plasticizers, crosslinkers, insolubilizers, starches, fillers, thickeners, rigid compounds, water resistance additives, flame retardants, lubricants, softening agents, antibacterial agents, antifungal agents, pigments, dyes, and any combination thereof.

Plasticizers may, in some embodiments, allow for tailoring the viscosity and/or affecting adhesive properties of SCE-adhesives of the present invention. Examples of plasticizers suitable for use in conjunction with SCE-adhesives of the present invention may include, but are not limited to, glycerin, glycerin esters, polyethylene glycol, diethylene glycol, polypropylene glycol, polyglycoldiglycidyl ethers, dimethyl sulfoxide, alkylphosphate esters, polycaprolactone, triethyl citrate, acetyl trimethyl citrate, dibutyl phthalate, diaryl phthalate, diethyl phthalate, dimethyl phthalate, di-2-methoxyethyl phthalate, dibutyl tartrate, ethyl o-benzoylbenzoate, ethyl phthalyl ethyl glycolate, methyl phthalyl ethyl glycolate, n-ethyltoluenesulfonamide, triacetin, triacetin, o-cresyl p-toluenesulfonate, trimethyl phosphate, triethyl phosphate, tributyl phosphate, triphenyl phosphate, tripropionin, polycaprolactone, and the like, any derivative thereof, and any combination thereof.

Crosslinkers may, in some embodiments, increase the adhesive properties and/or increase water resistance of SCE-adhesives of the present invention. Examples of crosslinkers suitable for use in conjunction with an SCE-adhesive of the present invention may, in some embodiments, include, but are not limited to, Lewis-acidic salts (e.g., magnesium salts, aluminum salts, and zirconium salts, and in particular chloride and nitrate salts thereof), boric acid, borate salts, phosphate salts, ammonium zirconium carbonate, potassium zirconium carbonate, metal chelates (e.g., zirconium chelates, titanium chelates, and aluminum chelates), formaldehyde crosslinkers, polyamide epichlorohydrin resin, crosslinkers like urea glyoxal adducts and alkylates thereof (e.g., methylated glyoxal adducts and N-methylolated glyoxal adduct derivatives), crosslinkers containing N-methylol groups, crosslinkers containing etherified N-methylol groups, and the like, any derivative thereof, and any combination thereof. Additional crosslinker examples may include N-hydroxymethyl-reactive resins like 1,3-dimethylol-4,5-dihydroxyimidazolidinone (4,5-dihydroxy-N,N′-dimethylolethyleneurea) or their at least partly etherified derivatives (e.g., derivatives with hydroxymethylated cyclic ethyleneureas, hydroxymethylated cyclic propyleneureas, hydroxymethylated bicyclic glyoxal diureas, and hydroxymethylated bicyclic malonaldehyde diureas). Examples of at least partly etherified derivatives of hydroxymethylated cyclic ethyleneureas may include, but are not limited to, ARKOFIX® products (e.g., for example ARKOFIX® NEC plus or ARKOFIX® NES (ultra-low formaldehyde crosslinking agents, available from Clariant SE Switzerland), glyoxal, urea formaldehyde adducts, melamine formaldehyde adducts, phenol formaldehyde adducts, hydroxymethylated cyclic ethyleneureas, hydroxymethylated cyclic thioethyleneureas, hydroxymethylated cyclic propyleneureas, hydroxymethylated bicyclic glyoxal diurea, hydroxymethylated bicyclic malonaldehyde diureas, polyaldehydes (e.g., dialdehydes), protected polyaldehydes (e.g., protected dialdehydes), bisulfite protected polyaldehydes (e.g., bisulfite protected dialdehydes), isocyanates, blocked isocyanates, dimethyoxytetrahydrafuran, dicarboxylic acids, epoxides, diglycidyl ether, hydroxymethyl-substituted imidazolidinone, hydroxymethyl-substituted pyrimidinones, hydroxymethyl-substituted triazinones, oxidized starch, oxidized polysaccharides, oxidized hemicellulose, and the like, any derivative thereof, and any combination thereof. Combinations of any of the foregoing examples may also be suitable. For example, hydroxymethylated compounds, at least partly etherified derivatives of hydroxymethylated compounds, dialdehyde-based compounds, and/or capped dialdehyde compounds may be useful in combination with Lewis-acidic salts. One skilled in the art with the benefit of this disclosure should understand that formaldehyde crosslinkers should be excluded from use in conjunction with formaldehyde-free SCE-adhesives, and limited in substantially formaldehyde-free SCE-adhesives.

Insolubilizer additives may, in some embodiments, increase the hydrophobic nature of the adhesive. Examples of insolubilizer additives for use in conjunction with SCE-adhesives of the present invention may, in some embodiments, include, but are not limited to, copolymers of polyvinyl alcohol and polyvinyl acetate, glyoxal, glycerin, sorbitol, dextrine, alpha-methylglucoside, and the like, and any combination thereof.

Water resistance additives may, in some embodiments, increase the water resistance properties of SCE-adhesives of the present invention, which may consequently yield articles capable of maintaining their mechanical properties in environments with higher water concentrations, e.g., humid environments. Examples of water resistance additives for use in conjunction with SCE-adhesives of the present invention may, in some embodiments, include, but are not limited to, waxes, polyolefins, insolubilizers, and any combination thereof.

Fillers may, in some embodiments, increase the rigidity of SCE-adhesives of the present invention, which may consequently increase the mechanical rigidity of an article produced therewith. Fillers suitable for use in conjunction with SCE-additives of the present invention may, in some embodiments, include, but are not limited to, coconut shell flour, walnut shell flour, wood flour, wheat flour, soybean flour, gums, starches, protein materials, calcium carbonate, zeolite, clay, rigid compounds (e.g. lignin), thickeners, and the like, and any combination thereof.

Flame retardants suitable for use in conjunction with SCE-additives of the present invention may, in some embodiments, include, but are not limited to, silica, organophosphates, polyhalides, and the like, and any combination thereof.

In some embodiments, SCE-adhesives of the present invention may be characterized as having a solids content (contributed to, at least in part, by some additives) ranging from a lower limit of about 4%, 8%, 10%, 12%, or 15%, to an upper limit of about 75%, 50%, 45%, 35%, or 25%, and wherein the solids content may range from any lower limit to any upper limit and encompass any subset therebetween.

In some embodiments, the SCE-adhesives of the present invention may comprise at least one substituted cellulose ester described herein (e.g., having any combination of: at least one organic ester substituent described herein, a degree of substitution of the organic ester substituent as described herein, at least one inorganic ester substituent described herein, a weight percent of the inorganic nonmetal atom of the inorganic ester substituent as described herein, and being derived from any suitable cellulosic source as described herein), a solvent described herein, and optionally additives as described herein (e.g., plasticizers, crosslinkers, insolubilizers, starches, fillers, thickeners, rigid compounds, water resistance additives, flame retardants, lubricants, softening agents, antibacterial agents, antifungal agents, pigments, dyes, and any combination thereof) and optionally be at least substantially formaldehyde-free.

### Synthesis of Substituted Cellulose Esters

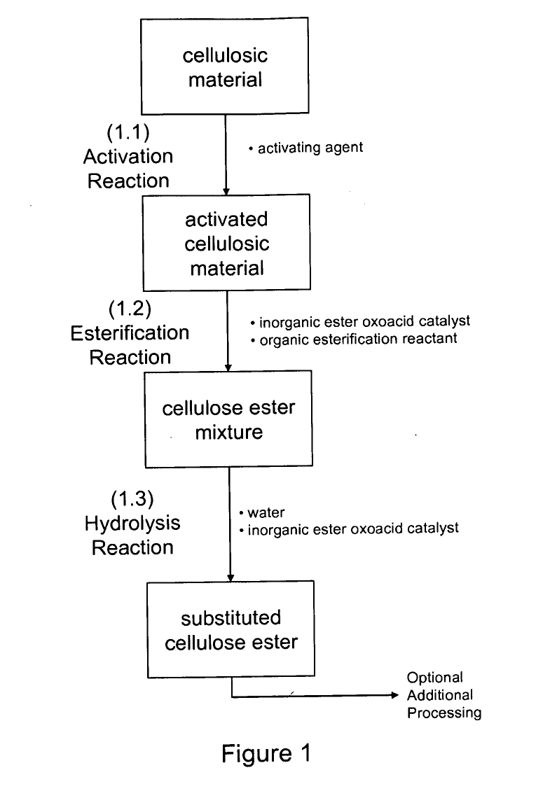

Substituted cellulose esters described herein may be produced utilizing one of several synthesis routes that, in some embodiments, comprise a hydrolysis reaction where water and inorganic ester oxoacid catalysts are added to a cellulose ester mixture so as to yield the substituted cellulose esters. Three nonlimiting examples of synthesis routes are illustrated in FIGS. 1-3.

Referring now to FIG. 1, in some embodiments, a cellulosic material may undergo (1.1) an activation reaction that swells the cellulosic material in the presence of an activating agent so as to make internal surfaces accessible for subsequent reactions, (1.2) an esterification reaction in the presence of an inorganic ester oxoacid catalyst and an organic esterification reactant so as to yield a cellulose ester mixture, and (1.3) a hydrolysis reaction in the presence of water and additional inorganic ester oxoacid catalyst so as to yield substituted cellulose esters. In some embodiments, the substituted cellulose esters may then optionally be further processed, e.g., to yield purified substituted cellulose esters. In some embodiments, the inorganic ester oxoacid catalyst of the (1.2) esterification reaction and the (1.3) hydrolysis reaction may be the same or different inorganic ester oxoacid catalysts.

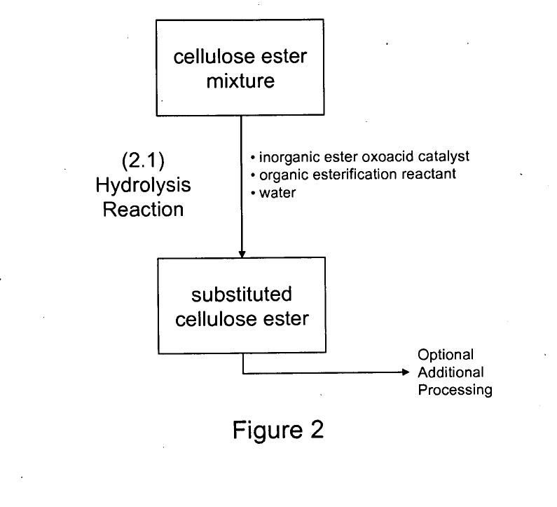

Referring now to FIG. 2, in some embodiments, synthesis of substituted cellulose esters may begin with the cellulose ester starting material, e.g., cellulose acetate. As shown in FIG. 2, a cellulose ester mixture (e.g., a swollen cellulose acetate in acetic acid) may undergo (2.1) a hydrolysis reaction in the presence of water, an inorganic ester oxoacid catalyst, and an organic esterification reactant, so as to yield substituted cellulose esters that may optionally be further processed.

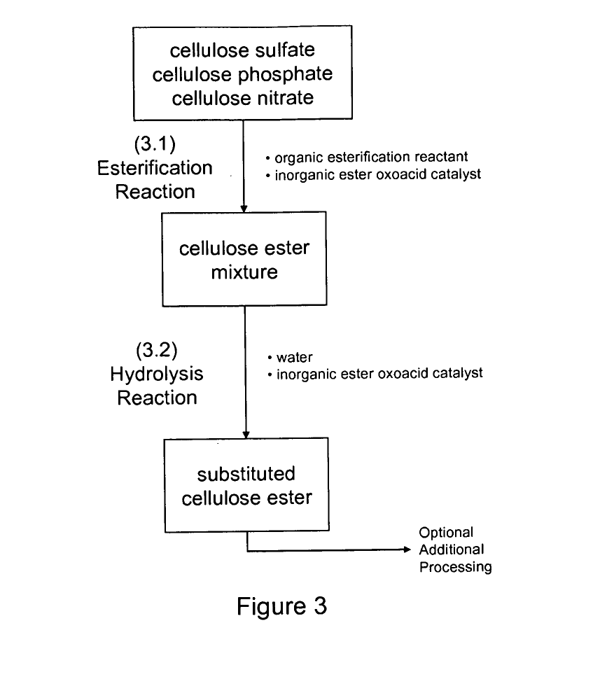

Referring now to FIG. 3, in some embodiments, synthesis of substituted cellulose esters may begin with a cellulose sulfate, cellulose phosphate, and/or cellulose nitrate starting material. As shown in FIG. 3, the cellulose sulfate, cellulose phosphate, and/or cellulose nitrate starting material may undergo (3.1) an esterification reaction in the presence of an inorganic ester oxoacid catalyst and an organic esterification reactant so as to yield a cellulose ester mixture, and optionally (3.2) a hydrolysis reaction in the presence of additional inorganic ester oxoacid catalyst so as to yield substituted cellulose esters that may optionally be further processed. In some embodiments, (3.2) the hydrolysis reaction may optionally further utilize water, as illustrated in FIG. 3. In some embodiments, the inorganic ester oxoacid catalyst of (3.1) an esterification reaction and optionally (3.2) a hydrolysis reaction may be the same or different inorganic ester oxoacid catalysts. One skilled in the art, with the benefit of this disclosure, should recognized that (3.2) the hydrolysis reaction is optional in this synthesis scheme as the starting material has inorganic ester substituents, some of which may be converted to organic ester substituents in (3.1) the esterification reaction, thereby yielding a substituted cellulose ester described herein.

As illustrated in the nonlimiting examples above, in some embodiments, the synthesis of substituted cellulose esters described herein may involve, inter alia, a hydrolysis reaction where inorganic ester oxoacid catalysts, water, and optionally other reactants are added to a cellulose ester mixture so as to yield the substituted cellulose esters. Further, it should be noted that in the nonlimiting examples above, the various chemical components may be mixed and/or added to the corresponding material and/or mixture in a plurality of sequences that may including multiple additions of any chemical component. In some preferred embodiments, hydrolysis reactions that include organic esterification reactants may be carried with adding the water after the inorganic ester oxoacid catalyst and the organic esterification reactant, so as to minimize potentially deactivating reactions between the water and the other reactants or intermediates thereof. In some preferred embodiments, hydrolysis reactions that do not include organic esterification reactants may be carried with concurrent addition of the water and the inorganic ester oxoacid catalyst, so as to minimize any potential degradation of the cellulose ester mixture by the inorganic ester oxoacid catalyst.

Suitable inorganic ester oxoacid catalysts for use in conjunction with synthesizing substituted cellulose esters described herein may include, but are not limited to, hypochlorous acid, chlorous acid, chloric acid, perchloric acid, sulfurous acid, sulfuric acid, sulfonic acids (e.g., taurine, toluenesulfonic acid, C₁-C₁₀ alkyl sulfonic acid, and aryl sulfonic acids), fluorosulfonic acids, nitrous acid, nitric acid, phosphorous acid, phosphoric acid, phosphonic acids, phosphinic acids, boric acid, and the like, any derivative thereof, and any combination thereof.

In some embodiments, inorganic ester oxoacid catalysts may be utilized in a hydrolysis reaction described herein in an amount sufficient to yield a substituted cellulose ester with at least 0.01% (w/w) of inorganic nonmetal atom to substituted cellulose ester and an organic ester degree of substitution of at least 0.2. In some embodiments, inorganic ester oxoacid catalysts may be utilized in a hydrolysis reaction described herein in an amount ranging from a lower limit of about 0.01% w/w, 0.1% w/w, 0.5% w/w, or 1% w/w of the inorganic nonmetal atom of the inorganic ester oxoacid catalyst (e.g., sulfur for sulfuric acid) to the cellulose ester to an upper limit of about 15% w/w, 10% w/w, 5% w/w, 1% w/w, or 0.5% w/w, and wherein the amount may range from any lower limit to any upper limit and encompass any subset therebetween. Without being limited by theory, it is believed that the inclusion of the inorganic ester oxoacid catalyst at higher concentrations may inhibit hydrolysis of the inorganic ester substituent, thereby yielding the high weight percent of the inorganic, nonmetal atom of the inorganic ester substituent in the final substituted cellulose ester product. It should be noted that such high concentrations and such high weight percents are referred to as relative to traditional methods of producing cellulose esters where, in some instances, the inorganic oxoacid is neutralized in hydrolysis reaction.

In some embodiments, a hydrolysis reaction may optionally include the addition of other reactants, e.g., inorganic esterification reactants. It is believed that, in some embodiments, the addition of inorganic esterification reactants (described further below) may facilitate formation of the inorganic ester substituent of the substituted cellulose ester being produced. In some embodiments, inorganic esterification reactants may be utilized in hydrolysis reactions described herein in an amount ranging from a lower limit of about 0.01%, 0.1%, 0.5%, or 1% by weight of the cellulose ester to an upper limit of about 10%, 5%, 1%, or 0.5% by weight of the cellulose ester, and wherein the amount may range from any lower limit to any upper limit and encompass any subset therebetween.

In some embodiments, water, inorganic ester oxoacid catalysts, and optionally other reactants may be added individually and/or in any combination to the cellulose ester mixture at the beginning of and/or throughout a hydrolysis reaction. By way of nonlimiting example, a hydrolysis reaction may involve adding water and sulfuric acid to a cellulose ester mixture at the beginning of a hydrolysis reaction, and then adding additional sulfuric acid and/or water throughout the reaction.

In some embodiments, a hydrolysis reaction may be carried out at a temperature ranging from a lower limit of about 35° C., 45° C., 55° C., 60° C., 63° C., 65° C., or 70° C. to an upper limit of about 90° C., 85° C., 80° C., 75° C., 70° C., or 68° C., and wherein the temperature may range from any lower limit to any upper limit and encompass any subset therebetween.

In some embodiments, a hydrolysis reaction may advantageously be carried out at a lower temperature and/or shorter reaction time. For example, in some embodiments, a hydrolysis reaction may be carried out at a temperature ranging from about 50° C. to about 75° C. for a reaction time of about 2 hours to about 7 hours. Shorter reaction times and/or lower temperatures may advantageously provide for, in some embodiments, hydrolysis reactions that are suitable to be scaled-up to industrial production of substituted cellulose esters.

As illustrated in the nonlimiting examples given above in relation to FIGS. 1-3, in some embodiments, cellulose ester mixtures suitable for use in a hydrolysis reaction may comprise cellulose esters. Cellulose esters suitable for use in cellulose ester mixtures described herein may include, but are not limited to, esterified cellulosic materials, esterified cellulose sulfate materials, esterified cellulose phosphate materials, esterified cellulose nitrate materials, already produced cellulose ester materials redissolved in a solvent, and the like, and any combination thereof.

Inorganic ester oxoacid catalysts suitable for use in conjunction with esterification reactions described herein may include, but are not limited to, those listed above that are suitable for use in conjunction with hydrolysis reactions described herein. In some embodiments, an esterification reaction and subsequent hydrolysis reaction may utilize the same or different inorganic ester oxoacid catalysts. By way of nonlimiting example, an esterification reaction may utilize sulfuric acid, and the subsequent hydrolysis reaction may utilize a mixture of sulfuric acid and methyl sulfonic acid so as to yield a substituted cellulose ester with two inorganic ester substituents.

Organic esterification reactants described herein may, in some embodiments, be utilized for forming the organic ester substituents of the substituted cellulose esters described herein. Organic esterification reactants suitable for use in conjunction with the synthesis of substituted cellulose esters described herein may include, but are not limited to, symmetric acid anhydrides, mixed acid anhydrides, or acyl chlorides of C₁-C₂₀ aliphatic carboxylic acids (e.g., acetic acid, propionic acid, or butyric acid), aromatic carboxylic acids (e.g., benzoic acid or phthalic acid), or substituted aromatic carboxylic acids. Combinations of organic esterification reactants may also be suitable, in some embodiments.

In some embodiments, the various reactions described herein may be conducted in a solvent. Solvents suitable for use in various reactions described herein may include, but are not limited to, acetic acid, acetic anhydride, water, and the like, and any combination thereof.

As illustrated in the nonlimiting examples above that referenced FIGS. 1-3, additional processes may be optionally performed after a hydrolysis reaction. Suitable additional processes may include, but are not limited to, precipitating the substituted cellulose ester, purification, washing, filtering, drying, and the like, and any combination thereof.

Precipitation of the substituted cellulose ester formed in the hydrolysis reaction may be achieved, in some embodiments, by the addition of a non-solvent. Non-solvents suitable for use in conjunction with precipitating substituted cellulose esters described herein may include, but are not limited to, water, water comprising an ionic strength modifier, acetone, methanol, ethanol, methylethyl ketone, dimethyl carbonate and the like, and any combination thereof.

To facilitate a better understanding of the present invention, the following examples of preferred or representative embodiments are given. In no way should the following examples be read to limit, or to define, the scope of the invention.

### Examples

### Example 1

Three substituted cellulose esters and two cellulose esters were produced and analyzed. Cellulose was treated with acetic acid and then mixed with a cooled solution of acetic acid, acetic anhydride, and sulfuric acid. The temperature of the resultant mixture was increased and allowed to react for about 20 minutes. At this point, cellulose ester compositions were hydrolyzed. To produce substituted cellulose esters, the mixture was hydrolyzed in the presence of additional sulfuric acid. Table 1 below provides the conditions for the production of the five samples.

TABLE 1

| | | | Acetyl Value | Sulfur | SO₄ |
|---|---|---|---|---|---|
| | | Temp | (% as acetic | Content | Content |
| | Time | (° C.) | acid) | (ppm) | (ppm) |
| CA-1 | 6 | 73.0 | 39.03 | 105 | 314 |
| CA-2 | 4.5 | 75.0 | 40.15 | 160 | 481 |
| SCA-1 | 6 | 65.0 | 41.43 | 807 | 2419 |
| SCA-2 | 4.5 | 70.0 | 38.02 | 268 | 805 |
| SCA-3 | 4.5 | 68.5 | 39.08 | 429 | 1286 |

This example is thought to demonstrate that substituted cellulose esters (specifically, substituted cellulose acetates) can be produced with high sulfur contents at relatively low temperatures and short hydrolysis times that are comparable to standard cellulose acetate hydrolysis times, which is advantageous in the commercial-scale production of substituted cellulose esters.

### Example 2

Several adhesive compositions (Adhesives 1-5) having varied solvents and substituted cellulose acetate compositions were tested for their adhesive properties in a variety of wood laminates. Further, two wood laminates were produced and analyzed with commercially available ELMER'S GLUE ALL® (a poly(vinyl acetate)-based adhesive, available from Elmer's Products, Inc.). Table 2 provides the wood laminate compositions, and Table 3 provides the results of Lap Shear tests conducted using INSTRON® (Model 3366) as a measure of the adhesive properties of the various adhesive compositions.

Upon visual inspection, the substituted cellulose acetate adhesives of this example were optically clear and had a high gloss, which may be desirable in some commercial applications.

To form the laminates, two small wooden blocks or two cardboard pieces were glued together using a 10% aqueous solution of the Adhesives 1-5 (Table 2) or ELMER'S GLUE ALL® (as noted) and allowed to dry. The resulting laminates were difficult to separate (i.e., none of the blocks broke in the tensile testing setup used or the cardboard failed before the adhesive bond). When enough force was applied to separate the blocks, the wood fibers broke which suggests that the substituted cellulose acetate adhesive is at least as strong as the wood fibers.

TABLE 2

| Sam- | | Solvent | Solids | Sulfur | Sub- | |
|---|---|---|---|---|---|---|
| ple | Adhesive | System | (wt %) | (mg/kg) | strate | Drying |
| 1 | ELMER'S | emulsion | 54 | — | card- | 1 hr |
| | GLUE ALL ® | | | | board | (ambient) |
| 2 | Adhesive 1 | aqueous | 10 | not | card- | 1 hr |
| | | | | measured | board | (ambient) |
| 3 | Adhesive 2 | aqueous | 20 | 4940 | wood | 2.25 hr |
| | | | | | | (ambient) |
| 4 | Adhesive 3 | aqueous | 15 | 4530 | wood | 2.25 hr |
| | | | | | | (ambient) |
| 5 | Adhesive 4 | mixed | 10 | 4940 | wood | 2.25 hr |
| | | organic/ | | | | (ambient) |
| | | aqueous | | | wood | 2.25 hr |
| 6 | Adhesive 2 | aqueous | 15 | 4940 | | (ambient) |
| 7 | ELMER'S | emulsion | 27 | — | wood | overnight |
| | GLUE ALL ® | | | | | (ambient) |
| 8 | Adhesive 5 | aqueous | 10 | 5570 | wood | 1 hr |
| | | | | | | (120° C.) |
| 9 | Adhesive 5 | aqueous | 10 | 5570 | wood | 1 hr |
| | | | | | | (120° C.) |
| 10 | Adhesive 5 | aqueous | 10 | 5570 | wood | 1 hr |

(120° C.)

TABLE 3

| | | | Addi- | Break | |
|---|---|---|---|---|---|
| Sam- | | | tional | Point | |
| ple | Adhesive | Substrate | Treatment | (kgf) | Comments |
| 1 | ELMER′S | cardboard | | 58.94 | paper failure |
| | GLUE ALL ® | | | | |
| 2 | Adhesive 1 | cardboard | | 43.86 | paper failure |
| 3 | Adhesive 2 | wood | | >107 | exceeded load |
| | | | | | cell capacity |
| 4 | Adhesive 3 | wood | | >107 | exceeded load |
| | | | | | cell capacity |
| 5 | Adhesive 4 | wood | | >107 | exceeded load |
| | | | | | cell capacity |
| 6 | Adhesive 2 | wood | | >107 | exceeded load |
| | | | | | cell capacity |
| 7 | ELMER'S | wood | | >107 | exceeded load |
| | GLUE ALL ® | | | | cell capacity |
| 8 | Adhesive 5 | wood | | >107 | exceeded load |
| | | | | | cell capacity |
| 9 | Adhesive 5 | wood | 1 hr | >107 | exceeded load |
| | | | (4° C.) | | cell capacity |
| 10 | Adhesive 5 | wood | 1 hr | >107 | exceeded load |
| | | | (4° C.) | | cell capacity |

It is believed that this example demonstrates, among many things, that substituted cellulose acetates with high sulfur content are effective as an adhesive on a variety of substrates.

### Example 3

Various additives were added to three adhesive compositions that comprise substituted cellulose acetate according to at least some embodiments described herein. The resulting compositions were tested for their adhesive properties on wood substrates (¼″ pine strips 1.5″ in width) using INSTRON® (Model 3366) Lap Shear test. Summaries of the results are shown below in Tables 4 and Table 5.

Adhesive 6 comprises substituted cellulose acetate having about 620 mg/kg of sulfur. To the Adhesive 6, varying amounts of ammonium zirconium carbonate were added. Table 4 provides the results of the Lap Shear test for the various compositions.

TABLE 4

| % Zr by wt of | Average | Average | |
|---|---|---|---|
| total solution | Break | Break | Stnd. |
| (% Zr by wt of solids) | (kgf)* | (psi)** | Dev. |
| 0 (0) | 179 | 263 | 32 |
| 0.04% (0.2%) | 271 | 398 | 110 |
| 0.08% (0.4%) | 280 | 411 | 35 |
| 0.16% (0.9%) | 300 | 441 | 71 |
| 0.32% (1.8%) | 362 | 532 | 45 |

*average of 6 replicates
**lap shear of 1.5″ x 1″ adhered area

Adhesives 7 and 8 comprise substituted cellulose acetates having about 520 mg/kg of sulfur and about 557 mg/kg of sulfur, respectively. To the Adhesives 7 and 8, varying amounts of additives were added. Table 5 provides the results of the Lap Shear test for the various compositions.

TABLE 5

| | Adhesive 7 | Adhesive 8 |
|---|---|---|
| | Break Point | Break Point |
| Additive | (kgf) | (kgf) |
| no additive | 225 | 349 |
| ammonium zirco- | 348 | 245 |
| nium carbonate | | |
| (14% by wt of solids) | | |
| polyvinylacetate | 271 | 210 |
| (MW~140,000) | | |
| (14% by wt of solids) | | |
| polyvinyl alcohol | not tested | 154 |
| (MW~150,000) | | |
| (14% by wt of solids) | | |

As shown in Table 4, the addition of zirconium can increase the strength required to break the bond formed by substituted cellulose ester adhesives. Further, Table 5 demonstrates the use of other polymer as plasticizer in substituted cellulose ester adhesives, which may advantageously allow for tailoring the adhesive strength of such compositions.

### Example 4

A plurality of adhesives samples were prepared by adding 8% by weight of a substituted cellulose acetate having about 1286 mg/kg sulfur to the desired solvent system as outlined in Table 6. The adhesive samples were mixed overnight. The crosslinkers (if applicable) were added in amounts outlined in Table 6, and the adhesive samples were mixed for about 2 minutes. The adhesive samples were used to adhere two blocks of pine wood together and allowed to dry for 15 minutes at 120° C. The Lap Shear test for was tested as described in Example 2.

TABLE 6

| | | | Break Point |
|---|---|---|---|
| Adhesive | Solvent | Crosslinker | (kgf) |
| 9 | 6 parts ethanol | none | 182.68 |
| 10 | 4 parts water | NES* (1%**) | 227.88 |
| 11 | | ZA* (0.5%) | 242.38 |
| 12 | 7 parts water | none | 161.45 |
| 13 | 2 parts ethanol | NES (1%) | 310.38 |
| 14 | 1 part acetone | ZA (0.5%) | 145.10 |
| 15 | 4 parts water | none | 109.60 |
| 16 | 1 part ethanol | NES (1%) | 202.96 |
| 17 | 5 parts acetone | ZA (0.5%) | 134.14 |
| 18 | 8 parts water | none | 138.89 |
| 19 | 1.5 parts dimethyl | NES (1%) | 189.30 |
| 20 | carbonate | NES (4%) | 379.44 |
| 21 | 0.5 parts acetone | ZA (0.5%) | 285.12 |
| 22 | | ZA (1%) | 349.53 |
| 23 | 7 parts water | none | 175.99 |
| 24 | 2 parts dimethyl | NES (1%) | 167.71 |
| 25 | carbonate | AZC* (1%) | 294.87 |
| | 1 part acetone | | |

*NES is modified dimethylol dihydroxy ethylene urea (available as ARKOFIX ® NES from Clariant), ZA is zirconium acetate, and AZC is ammonium zirconium carbonate.
**Crosslinker concentrations are by weight of the solids content of the sample.

This example demonstrates that both the crosslinker and the solvent system may affect the adhesive properties of substituted cellulose ester adhesives, which may allow for two additional handles that can be utilized in tailoring the adhesive properties for substituted cellulose ester adhesives for the desired application.

### Example 5

A plurality of adhesives samples were prepared by adding 12% by weight of a substituted cellulose acetate having about 997 mg/kg sulfur to the desired solvent system as outlined in Table 7. The adhesive samples were mixed overnight. The adhesive samples were used to adhere two blocks of pine wood together and allowed to dry for 15 minutes at 120° C. The Lap Shear test for was tested as described in Example 2.

TABLE 7

| Solvent System | | | | Break |
|---|---|---|---|---|
| dimethyl | | | | Point |
| carbonate | acetone | water | ethanol | (kgf) |
| 0 | 80 | 20 | 0 | 284.10 |
| 15 | 15 | 70 | 0 | 293.38 |
| 10 | 10 | 80 | 0 | 302.17 |
| 20 | 5 | 75 | 0 | 302.63 |
| 0 | 0 | 40 | 60 | 318.97 |
| 20 | 10 | 70 | 0 | 334.33 |
| 5 | 15 | 80 | 0 | 358.10 |
| 15 | 5 | 80 | 0 | 359.00 |
| 0 | 10 | 40 | 50 | 360.06 |
| 5 | 15 | 80 | 0 | 366.00 |
| 0 | 20 | 80 | 0 | 382.43 |
| 10 | 0 | 70 | 20 | 404.86 |

This example demonstrates that solvent system may affect the adhesive properties of substituted cellulose ester adhesives, which may allow for an additional handle that can be utilized in tailoring the adhesive properties for substituted cellulose ester adhesives for the desired application.

### Example 6

A plurality of adhesives samples were prepared by adding 8% by weight of a substituted cellulose acetate having about 1286 mg/kg sulfur to the desired solvent system as outlined in Table 8. The adhesive samples were mixed overnight. A crosslinker of NES at 1% by weight of the solids content of the sample and a crosslinker catalyst ad outlined in Table 8 (if applicable) at 1.5% by weight of the solids content of the sample were added to the adhesives samples, and the adhesive samples were mixed for about 2 minutes. The adhesive samples were used to adhere two blocks of pine wood together and allowed to dry for 15 minutes at 120° C. The Lap Shear test for was tested as described in Example 2.

TABLE 8

| | | | Break |
|---|---|---|---|
| Adhesive | Solvent | Crosslinker | Point (kgf) |
| 26 | 6 parts ethanol | None | 227.88 |
| 27 | 4 parts water | MgCl₂ | 165.69 |
| 28 | | AlCl₃ | 174.59 |
| 29 | 7 parts water | None | 310.38 |
| 30 | 2 parts ethanol | MgCl₂ | 271.45 |
| 31 | 1 part acetone | AlCl₃ | 175.57 |
| 32 | 4 parts water | None | 202.96 |
| 33 | 1 part ethanol | MgCl₂ | 144.42 |
| 34 | 5 parts acetone | AlCl₃ | 140.17 |

This example demonstrates that a crosslinker catalyst is not required to initiate crosslinking with the NES crosslinker, which typically does require such a crosslinker catalyst. Further, such crosslinker catalysts may reduce the adhesive properties of substituted cellulose ester adhesives.

### Example 7

Two samples of substituted cellulose acetates were derived from hardwood or softwood having about 1290 mg/kg sulfur or about 1000 mg/kg sulfur, respectively. Each substituted cellulose ester sample was used in producing an SCE-adhesive having 12% solids and no crosslinkers in a solvent system of 60% ethanol and 40% water. The adhesive samples were used to adhere two blocks of either pine or birch wood together and allowed to dry for 15 minutes at 120° C. The Lap Shear test for was tested as described in Example 2.

As reported in Table 9, the use of the softwood-derived cellulose acetate yielded a stronger adhesive, e.g., about 60% higher lap strength when adhering pine and about 20% higher lap strength when adhering birch, which demonstrates that the cellulosic source from which a substituted cellulose ester is derived may affect the adhesive properties of the resultant SCE-adhesive.

TABLE 9

| | | Average | |
|---|---|---|---|
| | | Break | Stnd. |
| Pulp | Substrate | (kgf)* | Dev. |
| hardwood | pine | 280 | 10 |
| hardwood | birch | 452 | 8 |
| softwood | pine | 445 | 17 |
| softwood | birch | 549 | 9 |

*average of 2 replicates

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a cellulose ester mixture that comprises a cellulose ester and a solvent; and
hydrolyzing a mixture that comprises a cellulose ester mixture, water, and an inorganic ester oxoacid catalyst so as to yield a substituted cellulose ester having a cellulose backbone with an organic ester substituent and an inorganic ester substituent derived from the inorganic ester oxoacid catalyst.

2. The method of claim 1, wherein the substituted cellulose ester has a degree of substitution of the organic ester substituent of at least 0.2.

3. The method of claim 1, wherein the inorganic ester substituent comprises an inorganic, nonmetal atom, and wherein the substituted cellulose ester has at least 0.01% of the inorganic, nonmetal atom by weight of the substituted cellulose ester.

4. The method of claim 1, wherein the inorganic ester oxoacid catalyst comprises at least one selected from the group consisting of hypochlorous acid, chlorous acid, chloric acid, perchloric acid, sulfurous acid, sulfuric acid, a sulfonic acid, taurine acid, toluenesulfonic acid, C₁-C₁₀ alkyl sulfonic acid, aryl sulfonic acid, a fluorosulfonic acid, nitrous acid, nitric acid, phosphorous acid, phosphoric acid, a phosphonic acid, a phosphinic acid, an alkyl phosphoric acid, boric acid, any derivative thereof, and any combination thereof.

5. The method of claim 1, wherein the mixture further comprises an organic esterification reactant.

6. The method of claim 5, wherein the organic esterification reactant comprises at least one selected from the group consisting of a symmetric acid anhydride, a mixed acid anhydride, an acyl chloride of at least one carboxylic acid selected from the group consisting of a C₁-C₂₀ aliphatic carboxylic acid, acetic acid, propionic acid, butyric acid, an aromatic carboxylic acid, benzoic acid, phthalic acid, and a substituted aromatic carboxylic acid.

7. The method of claim 1, wherein hydrolysis occurs at a temperature between about 35° C. and about 90° C.

8. The method of claim 1, wherein hydrolysis occurs at a temperature between about 45° C. to about 75° C. for a reaction time of about 2 hours to about 7 hours.

9. The method of claim 1, wherein the cellulose ester is derived from at least one selected from the group consisting of cellulose, cellulose phosphate, cellulose sulfate, cellulose nitrate, and any combination thereof.

10. The method of claim 1, wherein the organic ester substituent comprises at least one selected from the group consisting of a C₁-C₂₀ aliphatic ester, acetate, propionate, butyrate, an aromatic ester, a substituted aromatic ester, any derivative thereof, and any combination thereof.

11. The method of claim 1, wherein the inorganic ester substituent comprises at least one selected from the group consisting of hypochlorite, chlorite, chlorate, perchlorate, sulfite, sulfate, a sulfonate, taurine, toluenesulfonate, C₁-C₁₀ alkyl sulfonate, aryl sulfonate, fluorosulfate, nitrite, nitrate, phosphite, phosphate, a phosphonate, a phosphonite, an alkyl phosphate, borate, any derivative thereof, and any combination thereof.

12. An adhesive comprising the substituted cellulose ester synthesized by the method of claim 1.

13. A method comprising:
swelling a cellulosic material in the presence of an activating agent, thereby yielding an activated cellulose;
esterifying the activated cellulose in the presence of a first inorganic ester oxoacid catalyst and an organic esterification reactant, thereby yielding a cellulose ester mixture; and
hydrolyzing the cellulose ester mixture in the presence of water and a second inorganic ester oxoacid catalyst, thereby yielding a substituted cellulose ester.

14. The method of claim 13, wherein the first inorganic ester oxoacid catalyst and the second inorganic ester oxoacid catalyst are the same.

15. A method comprising:
esterifying a cellulosic material in the presence of a first inorganic ester oxoacid catalyst and an organic esterification reactant, thereby yielding a cellulose ester mixture, the cellulosic material comprising at least one selected from the group consisting of cellulose sulfate, cellulose phosphate, cellulose nitrate, and any combination thereof; and
hydrolyzing the cellulose ester mixture in the presence of water and a second inorganic ester oxoacid catalyst, thereby yielding a substituted cellulose ester.

16. The method of claim 15, wherein the first inorganic ester oxoacid catalyst and the second inorganic ester oxoacid catalyst are the same.

17. An adhesive comprising:
a substituted cellulose ester having a cellulose backbone with an organic ester substituent and an inorganic ester substituent, wherein the adhesive is substantially formaldehyde-free.

18. The adhesive of claim 17, wherein the substituted cellulose ester has a degree of substitution of the organic ester substituent of at least 0.2.

19. The adhesive of claim 17, wherein the inorganic ester substituent comprises an inorganic, nonmetal atom, and wherein the substituted cellulose ester has at least 0.01% of the inorganic, nonmetal atom by weight of the substituted cellulose ester.

20. The adhesive of claim 17 further comprising:
at least one selected from the group consisting of a solvent, a plasticizer, a crosslinker, an insolubilizer, a starch, a filler, a thickener, a rigid compound, a water resistance additive, a flame retardant, a lubricant, a softening agent, an antibacterial agent, an antifungal agent, a pigment, a dye, and any combination thereof.

21. An article that comprises at least one wood substrate and the adhesive of claim 17 disposed on at least a portion of the surface of the wood substrate.
